(19) United States
(12) Patent Application Publication
(10) Pub. No.: US 2026/0311630 A1
(43) Pub. Date: Oct. 8, 2026

(54) INTEGRATED CIRCUIT FOR CONNECTING A HEADLAMP LIGHT SOURCE MODULE TO A BUS

(71) Applicant: HELLA GMBH & CO. KGAA, Lippstadt (DE)

(72) Inventors: Alberto Encinas, Lippstadt (DE); Florian Herold, Bielefeld (DE); Ingo Möllers, Rietberg (DE); Patrick Vogel, Unna (DE); Frank Warschitzka, Lippstadt (DE)

(21) Appl. No.: 19/682,810

(22) Filed: May 20, 2026

Related U.S. Application Data
(63) Continuation of application No. PCT/EP2024/081277, filed on Nov. 6, 2024.

(30) Foreign Application Priority Data
Nov. 23, 2023 (DE) 102023132626.0

(51) Int. Cl. G09G 3/20; B60Q 1/14

(52) U.S. Cl. CPC G09G 3/2096; B60Q 1/1415; G09G 2370/04; G09G 2380/10

(57) ABSTRACT

The present invention relates to an integrated circuit, for example an application-specific integrated circuit, for connecting a headlamp light source module of a vehicle to a bus of the vehicle. The integrated circuit has a first interface for connecting to the bus, and this first interface is an Ethernet interface. The integrated circuit has at least one second interface for connecting to the headlamp light source module, and this at least one second interface is a video interface.

### CROSS-REFERENCE TO RELATED APPLICATIONS

This application is a continuation of PCT/EP 2024/081277, filed Nov. 6, 2024, which claims priority to German Patent Application DE 10-2023-132-626.0, filed Nov. 23, 2023, the disclosures of which are incorporated by reference in their entirety.

### FIELD OF THE INVENTION

The invention relates to a circuit for connecting a headlamp light source module of a vehicle to a bus of the vehicle.

### BACKGROUND OF THE INVENTION

LED matrix headlamps have been used in vehicles for several years. For example, the applicant manufactures lighting systems for vehicles under the name SSL-HD, which can be used as headlamps in vehicles. SSL-HD stands for “Solid State Lightning-High Definition”. The matrix used in such a lighting system has 30,000 pixels, which are formed by LEDs. Depending on the traffic situation, the matrix can be used to generate a light pattern that provides optimum lighting and avoids blinding other road users. The brightness of each LED can be controlled for this purpose. Controlling each individual LED requires a large number of control instructions to be transmitted from a vehicle control unit to the LED matrix headlamp.

It is planned that light sources with around 100,000 pixels will be used in LED matrix headlamps in the future. In addition, there is currently a trend in automotive engineering to use fewer but more centralized control units that are intended for different functions or assemblies of the vehicle instead of many, special and distributed control units in vehicles.

Both make it necessary to use bus systems in the vehicle with which large amounts of data can be transmitted.

This requirement can be met by Ethernet buses. Ethernet technology has been in daily use for decades in various applications, in particular outside the automotive industry. It has proven itself and has been and continues to be developed further, in particular the bandwidth of Ethernet connections has been steadily increased. For example, high-bandwidth Ethernet buses have also been developed to achieve the high data rates that will be required for LED matrix headlamps with LEDs with 100,000 pixels.

### SUMMARY OF THE INVENTION

A circuit according to the invention includes: an interface for connecting to the bus, wherein this first interface is an Ethernet interface; and an interface for connecting to the headlamp light source module, wherein this at least one second interface is a video interface. With the integrated circuit according to the invention, it is possible to establish a connection between the Ethernet and the headlamp light source module, which comprises the LED matrix. The integrated circuit is suitable and set up to convert instructions from a control unit for generating light images using the matrix into video signals that the headlamp light source modules can process to generate these light images.

The instructions that the circuit according to the invention receives from the control unit can be generated and transmitted in a format that is independent of the light source module used and the video data or control instructions required by the light source module. The integrated circuit makes it possible to generate video data and control instructions from the data received from the control unit, which are adapted to the connected light source module. The integrated circuit can be suitable for providing alternative or parallel video signals or control instructions in different formats and at different second interfaces, so that the integrated circuit makes it possible to connect light source modules from different manufacturers or of different types to the Ethernet in vehicles via the integrated circuit. This means that light source modules for vehicles of the same type can be sourced from different suppliers. The integrated circuit allows the light source module to be adapted to the rest of the vehicle.

According to the invention, the second interface or one of the second interfaces can be an interface for an RGB signal. The second interface or one of the second interfaces can be an SPI (Serial Peripheral Interface). Any type of SPI can be used, including a Q-SPI.

The second interface can be a bidirectional interface. The first interface can also be a bidirectional interface.

The second interface can also be suitable and set up for transmitting control instructions and/or sensor signals.

It is possible that both the first and second interfaces or the second interfaces are formed by function blocks of the integrated circuit, unless they are mechanical elements, for example connectors.

In addition to the first and at least one second interface, the circuit can have at least one further interface for connecting to the headlamp light source module, wherein this at least one third interface is an interface for control instructions and sensor signals. The third interface can be formed by a universal asynchronous receiver transmitter (UART), which can be a function block of the integrated circuit. Mechanical elements of the third interface are also preferably not part of the integrated circuit.

The integrated circuit can be an application specific integrated circuit (ASIC), which is particularly advantageous. In particular, this makes the use of more generally applicable microcontrollers unnecessary, with which more functions may be realized, but which are more expensive than application-specific integrated circuits above a certain quantity.

### BRIEF DESCRIPTION OF THE DRAWING

The invention is explained in more detail with reference to the drawing. In the drawing:

FIG. 1 is a schematic representation of an arrangement comprising an integrated circuit according to the invention.

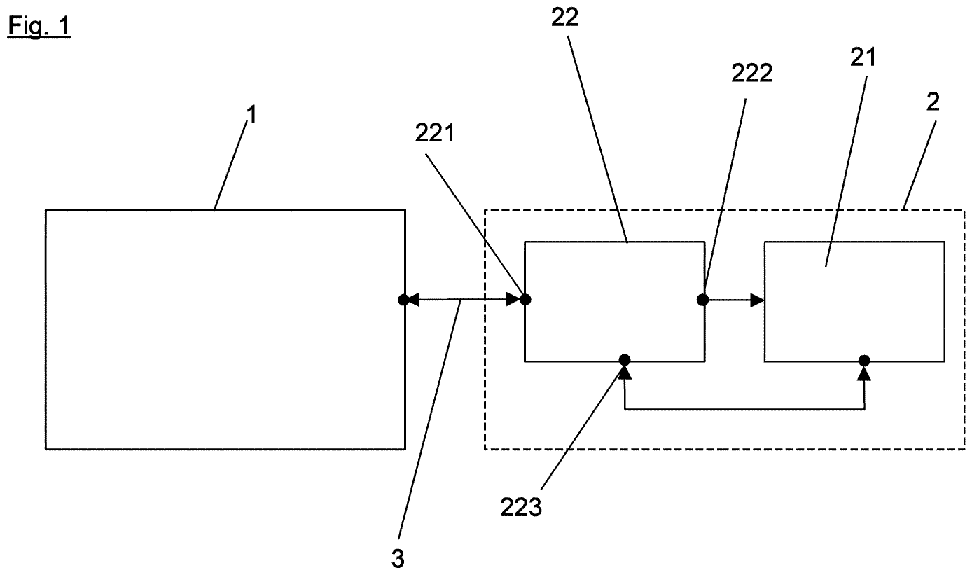

### DETAILED DESCRIPTION OF THE CURRENT EMBODIMENT

The arrangement comprises a central control unit 1 and a headlamp 2, which are connected to each other via an Ethernet bus 3. The headlamp has a headlamp light source module 21 and an integrated circuit 22, which may be an application-specific integrated circuit.

A signal can be transmitted from the control unit 1 via the bus 3, which specifies the images to be generated with the light source module 21. Control instructions and sensor data can also be exchanged via bus 3. A bidirectional exchange between the control unit 1 and the headlamp 2 is possible via bus 3.

The integrated circuit 22 has three interfaces. A first interface 221 forms an external interface of the headlamp 2 and is connected to the bus 3. This is an Ethernet interface. A second interface 222 is used to transmit a video signal which is generated in the integrated circuit 2 from the video data transmitted from the control unit 1 to the headlamp 2 via the bus 3 and the first interface 221 of the integrated circuit 22, and which is transmitted to the light source module 21 via the second interface. A third interface 223 of the integrated circuit 22 is formed by a universal asynchronous receiver transmitter. It serves as an interface for the bidirectional exchange of control and sensor signals between the integrated circuit 22 and the light source module 21.

The light source module 21 has an LED matrix light source consisting of a large number (up to 100,000) of pixels. Said pixels are substantially controlled by the integrated circuit 22 by means of the video signal transmitted via the second interface 222, which may be an SPI signal or an RGB signal. The LEDs are then used to generate the images required by the control unit. Further control data can be transmitted together with the video signal. An integrated circuit according to the invention could also have two or more second interfaces, for example one for a Q-SPI signal and one for an RGB signal.

### LIST OF REFERENCE SIGNS

1 control unit
2 headlamp
21 headlamp light source module
22 integrated circuit
221 first interface
222 second interface
223 third interface
3 Ethernet bus

The above description is that of current embodiments of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. An integrated circuit for connecting a headlamp light source module of a vehicle to a bus of the vehicle, the integrated circuit comprising:
an interface configured to connect to the bus, wherein the interface is an Ethernet interface; and
at least one interface configured to connect to the headlamp light source module, wherein the at least one interface is a video interface.

2. The integrated circuit of claim 1, wherein the at least one interface is an interface for an RGB signal.

3. The integrated circuit of claim 1, wherein the at least one interface is a serial peripheral interface (SPI).

4. The integrated circuit of claim 1, wherein at least one of the interface configured to connect to the bus or the at least one interface configured to connect to the headlamp light source module is a bidirectional interface.

5. The integrated circuit of claim 1, wherein the at least one interface configured to connect to the headlamp light source module is further configured to transmit at least one of control instructions or sensor signals.

6. The integrated circuit of claim 1, wherein the interface configured to connect to the bus and the at least one interface configured to connect to the headlamp light source module are formed by function blocks of the integrated circuit.

7. The integrated circuit of claim 1, further comprising at least one further interface configured to connect to the headlamp light source module, wherein the at least one further interface is configured to transmit control instructions and sensor signals.

8. The integrated circuit of claim 7, wherein the at least one further interface comprises a universal asynchronous receiver transmitter (UART) formed as a functional block of the integrated circuit.
